(19) United States
(12) Patent Application Publication
(10) Pub. No.: US 2004/0244219 A1
(43) Pub. Date: Dec. 9, 2004

(54) Apparatus for drying the surface of aggregate and aggregate/binder mixtures

(76) Inventor: Michael L. Dicke, St. Marys, OH (US)

Correspondence Address: GALLAGHER & DAWSEY CO., L.P.A., P.O. BOX 785, COLUMBUS, OH, 43216, US

(21) Appl. No.: 10/455,093

(22) Filed: Jun. 5, 2003

(51) Int. Cl. F26B 19/00; F26B 25/06

(52) U.S. Cl. 34/218; 34/201

(57) ABSTRACT

An apparatus for the drying of aggregate and aggregate-binder mixtures includes a housing containing a fan within a housing that pulls air through various materials held in a drying sieve, or multiple drying sieves, and then exhausts the air to the ambient environment. The apparatus is particularly useful in determining the saturated surface dry state of materials which is an important factor in various testing procedures. The apparatus may include activation means, such as switches and controls, and may incorporate weight sensors to aid in determining the drying state of the material. Various input, output, memory, and display functions are provided to allow calculations and display of observed and calculated indicia.

### TECHNICAL FIELD

The present invention relates generally to paving materials, and in particular, to an apparatus for determining liquid absorption by aggregate or binder-aggregate mixtures. The method and apparatus aids in determining the saturated surface dry state of such mixtures as an aid in designing effective compositions.

### BACKGROUND OF THE INVENTION

Most paved surfaces, including roadways, consist of a plurality of materials and layers. Typically, these mixtures include a binder such as cement or asphalt-cement, and a plurality of different aggregates composed of rocks, stones, or other materials. These paving mixtures are described as “compacted mixtures.”

The composition of these compacted mixtures is an important factor in the service life of the construction project. In order to predict a certain minimum service life, most paving projects require conformance to predetermined minimum build specifications or standards. Among these standards are requirements relating to the capacity of the aggregate or binder-aggregate material to absorb fluid. To properly design a paving mix, by way of example and not limitation, asphalt paving mixes, the proper amount of binder must be added to a given amount of aggregate in order to maintain a mixture which will result in a strong and durable paved surface. If there is too much binder, that is for example, too much asphalt-cement in an asphalt-aggregate paving mix, the paved surface will be soft and excessive wear and rutting will result. If there is not enough binder in the composition, the paved surface will be brittle and will crumble or break apart, particularly under loading stresses associated with vehicular traffic.

A particularly difficult problem in designing appropriate mixtures lies in the fact that aggregates, such as rock and stone, are not hydraulically neutral agents. That is, they have the ability to both absorb fluid, such as binder and water, into their interior matrix and to adsorb fluid onto their surfaces. When binder, such as asphalt-cement, is absorbed internally into a porous aggregate, that absorbed binder does not contribute to the effective volume of the asphalt mix. In order to account for this absorbed binder, additional binder must be added to the mix. The need to add such compensatory binder can lead to incorrect formulation of the mix. The measurement of the binder absorbed by the aggregate which does not contribute to the volume of the asphalt mix is the percent absorption (PA), by weight, of water absorbed into the aggregate relative to the weigh of the aggregate itself.

In general, the procedure for testing aggregate for PA involves saturating the internal matrix of the aggregate, and then drying the aggregate to determine the amount of fluid that has been internally absorbed. As a first step, a sample of dry aggregate is prepared to a condition where the internal voids are saturated by water, but the external surface of the aggregate is dry. This condition is known as the saturated surface dry (SSD) state. The sample is then dried completely in an oven, and weighed again in the dry state. The difference between the SSD and dry weights, divided by the dry weight, converted to a percentage, is the PA.

Additionally, asphalt-aggregate mixes are commonly tested for specific gravity and density using what is usually denominated the “Rice test.” Such a test also requires surface drying of the sample before testing.

Besides the necessity of thoroughly saturating the tested material to establish a baseline for fluid absorption, an obvious difficulty in this process is drying the surface of the material after saturation to the point where the surface of the material is dry, but where fluid is not extracted from the internal matrix.

One method of preparing a sample of material to the SSD condition is what is known as the “towel dry” method. In this method, totally saturated material, generally aggregate, is lightly hand dried with paper towels to just the point where the aggregate surface is dry. This technique is best used for larger aggregate such as that for concrete. Obviously, it suffers from the necessity for hand labor and the crude estimation of surface drying that must be made.

Another method is a “slump test,” used for both concrete and asphalt aggregates, where a cone of saturated aggregate is allowed to slump following removal of a cone shaped form. Saturated aggregate will tend to retain a cone shape, while surface dried aggregate will tend to slump. This method suffers from observational error induced by the subjective judgment of slump made by technicians, and for differences in various aggregates' tendency to slump based on factors other than surface moisture, such as angularity or fineness of the aggregate.

There are constraints on the methods that maybe used for drying the aggregate surface, in order to prevent more than a negligible amount of internal fluid being driven off before the SSD weight can be calculated. Foremost among these is the avoidance of external heat in the drying, as such heat tends to drive fluid from the internal matrix to the surface of the aggregate. Additionally, heat is avoided during drying of asphalt-aggregate mixtures to avoid thermal effects on the asphalt binder.

Determination of the SSD state of an asphalt-aggregate mixture is also critical in measuring the percentage of air voids in a compacted mixture, an important parameter for estimating wear effects and service life of a paving product.

First the bulk specific gravity (G_{mb}) of a compacted asphalt mixture is determined. The procedure requires that the compacted mix be weighed in air, submerged, and in the SSD state, and is determined by the following equation:

G_{mb}=A/(B−C)

Where:

G_{mb}=Bulk specific gravity of the collected specimen

A=Oven dry mass (g)

B=SSD mass (g)

C=Submerged mass (g)

The bulk specific gravity (G_{mb}) can then be employed in a standard test method to assess fluid absorption in asphalt-aggregate mixtures in ASTM 2041, known as “Theoretical Maximum Specific Gravity and Density of Bituminous Paving Mixtures Dry Back Process.” For the Rice test, a sample of the mixture is broken up into a voidless mass of particles less than 4.75 mm (0.25 in.) in size. The sample is placed in a calibrated container. The weight and volume of the voidless mix are then used to calculate the maximum specific gravity as shown in the following equation:

Gₘₘ=A/(A−C)

Where:

Gₘₘ=Theoretical maximum specific gravity

A=Mass of oven dry sample in air, (g)

C=Mass of water displaced by sample at 25° C. (77° F.), (g)

The bulk specific gravity of the collected specimen (G_{mb}) and the theoretical maximum specific gravity (Gₘₘ) can then be used to calculate the air void content of the compacted material, according to the following equation:

Vₐ=(1−(G_{mb}−Gₘₘ))×100

Where:

Vₐ=Air voids in the compacted mix, percent

G_{mb}=Bulk specific gravity of the compacted mix

Gₘₘ=Theoretical maximum specific gravity of the mix

The derivation of these measurements requires an efficient means of determining the saturated surface dry (SSD) state of an aggregate or mixture. Typically, an ad hoc drying method is used in laboratories, similar to the arrangement seen in FIG. 1, such as placing the saturated material in a drying sieve (S), and then blowing air from a household fan (F) through the aggregate. The sieve (S) must be propped up upon some auxiliary device (P), generally another sieve, to permit air to flow through the sieve (S) and exit between the sieve (S) and the work surface (WS). In this configuration an extension device (E), often yet another sieve, must be used to provide some space between the fan (F) and the contents of the sieve (S). To achieve a reasonable seal and volume of air blown through the material, the fan is often set atop the drying sieve, with a prop underneath the sieve to allow air circulation, a cumbersome solution that sometimes leads to spillage of the pan contents and the need to begin the test anew. The fan is removed periodically to stir the material to assist in drying, and at any point the fan may fall off of the sieve, in particular as the designs of many fans do not allow for a symmetrical weight distribution on the sieve, again as seen in FIG. 1. The weight of the material, subtracting the tare weight of the drying sieve, approximates the SSD weight when successive weighings of the material vary by no more than 0.05%.

Because of the inefficiency of a fan perched atop the sieve, drying time is often excessive. For example, a typical 1500-2000 gram sample takes approximately two hours, or more, to dry to the level upon with testing for the approach of SSD weigh can begin. The need to periodically remove the fan, stir the sieve contents, and repeatedly weigh the sieve consumes an inordinate amount of technician time and increases the possibility of error.

What the art has needed is a drying apparatus that is capable of air drying the surface of mixtures to be tested, without the application of external heat, that is simple, inexpensive, easy to use, and, most importantly, fast. The apparatus should be stable and resist inadvertent spilling of the material while drying. Lastly, the material must be easily and reliably removable from the drying apparatus so that successive weighings can be carried out. Optimally, in some embodiments the drying device may be equipped to automatically perform the weighing operations. The instant invention satisfies these needs.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways, thereby reducing drying time by as much as 50% over conventional methods. In one of the simplest configurations, the apparatus incorporates a means for drying the surface of material in at least one drying sieve. The apparatus includes a housing, at least one discharge opening, a fan assembly within the housing, and an activation device to control the operation of the fan assembly. The top surface of the housing has at least one sieve opening to cooperate with at least one sieve to permit fluid communication between the housing interior space and the surrounding atmosphere. The at least one discharge opening is formed in the housing fluidly connecting the interior space of the housing with the surrounding atmosphere. The fan assembly is oriented to draw air from the surrounding atmosphere through the mixture in the at least one sieve and the at least one sieve opening and to discharge air through the at least one discharge opening to the surrounding atmosphere. Lastly, the activation device controls the operation of the fan assembly.

The housing may be of virtually any shape than defines an interior space and may include at least one drain hole formed in the housing bottom surface to permit fluid that may accumulate in the housing to drain from the housing. The bottom surface may be formed to pitch toward the at least one drain hole. The housing may be constructed of virtually any material, including coated materials. The housing may be elevated from an external surface by at least one support device, which may be as simple as fixed legs, or may include more advanced adjustability and rotational features.

The at least one discharge opening of the fan assembly may be located on any of the surfaces of the enclosure and may be fitted with various accessories, such as a safety screen, sound attenuator, or exhaust ductwork.

In one particular embodiment, the fan assembly consists of a housed fan having a fan housing, a fan wheel, and a motor. Alternative embodiments may incorporate a plurality of fans. The fan assembly may be mounted in the housing in a number of ways, such as rigidly attached to the housing, or mounted to the housing with a vibration isolation system.

The apparatus includes the activation device for controlling the operation of the fan assembly. Such activation device may be as simple as a plug style connector to cooperate with a common electrical connector, or may involve more complex controls, such as electronic controls or variable speed drive controls. Further embodiments may include a weight measuring system having at least one weight sensor and at least one display device. The at least one weight sensor may be formed as a sieve receiver adapted to receive and releasably hold the sieve over the sieve opening, or may include multiple sensors to cooperate with the sieve, or may be part of the at least one support device. Having the weight sensor as part of the at least one support device would be particularly useful in the single sieve opening embodiment, as the fan assembly would not have to be turned off during the reading since the at least one weight sensor will be measuring the weight of the entire apparatus rather than just the sieve and its contents.

A control module may be adapted to receive data from the weight measuring system and at least one input device. The at least one input device may be any number of external devices such as a keyboard, or may include an input device built into the control module. The control module may then perform calculations, and display data on one at least one display device. The control module may also include memory to retain the input and output data. The calculations performed may include bulk specific gravity of the compacted specimen, the theoretical maximum specific gravity, and the air void percentage in the compacted mix, according to the equations seen above. Further, the control device may incorporate the function of the activation device in controlling the operation of the fan assembly. Additionally, the control module may be adapted to transmit data to at least one printer, either external to the apparatus or integral to the control module.

These variations, modifications, alternatives, and alterations of the various preferred embodiments, arrangements, and configurations may be used alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 shows a prior art setup for drying the surface of aggregate, in side elevation view, not to scale;

FIG. 2 shows an embodiment of the apparatus for drying the surface of aggregate in elevated perspective view, not to scale;

FIG. 3 shows the apparatus of FIG. 1 in top plan view, not to scale;

FIG. 4 shows the apparatus of FIG. 1 in cross-sectional view taken along section line 4-4 in FIG. 3, not to scale;

FIG. 5 shows a variation of the apparatus of FIG. 1 in cross-sectional view taken along section line 4-4 in FIG. 3, not to scale;

FIG. 6 shows a variation of the apparatus of FIG. 1 in cross-sectional view taken along section line 4-4 in FIG. 3, not to scale;

FIG. 7 shows an embodiment of the apparatus for drying the surface of aggregate in elevated perspective view, not to scale;

FIG. 8 shows an embodiment of the apparatus for drying the surface of aggregate in elevated perspective view, not to scale; and

FIG. 9 shows a variation of the apparatus of FIG. 1 in top plan view, not to scale.

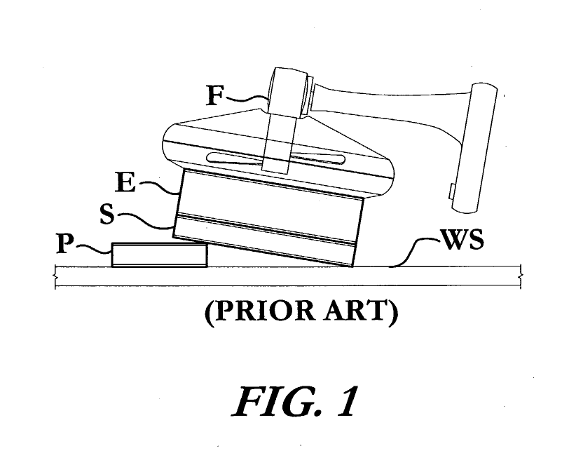

### DETAILED DESCRIPTION OF THE INVENTION

The apparatus for drying the surface of aggregate of the instant invention enables a significant advance in the state of the art. The preferred embodiments of the apparatus accomplish this by new and novel arrangements of elements and methods that are configured in unique and novel ways and which demonstrate previously unavailable but preferred and desirable capabilities.

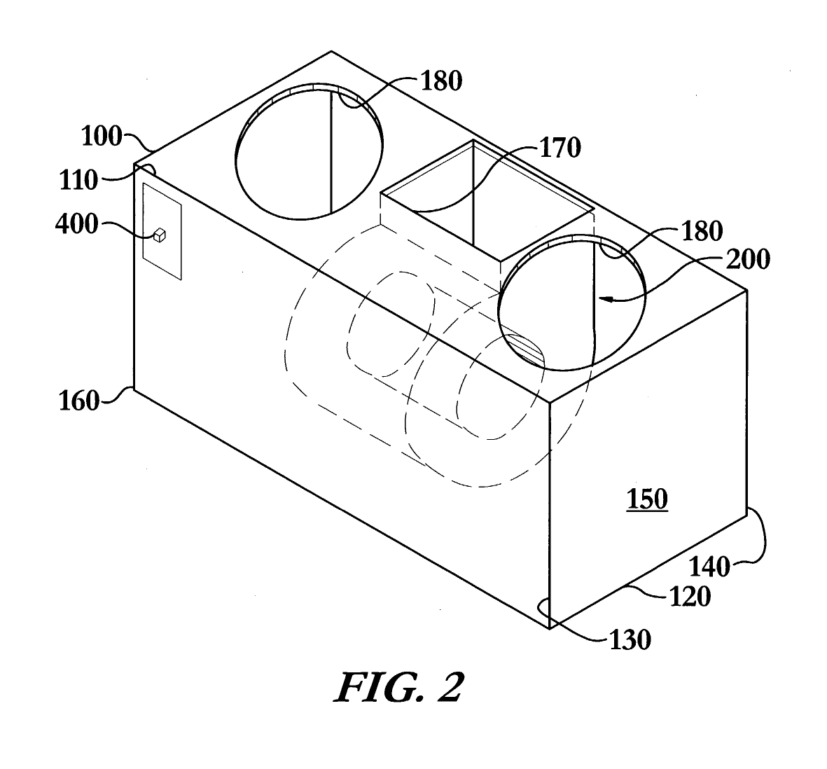

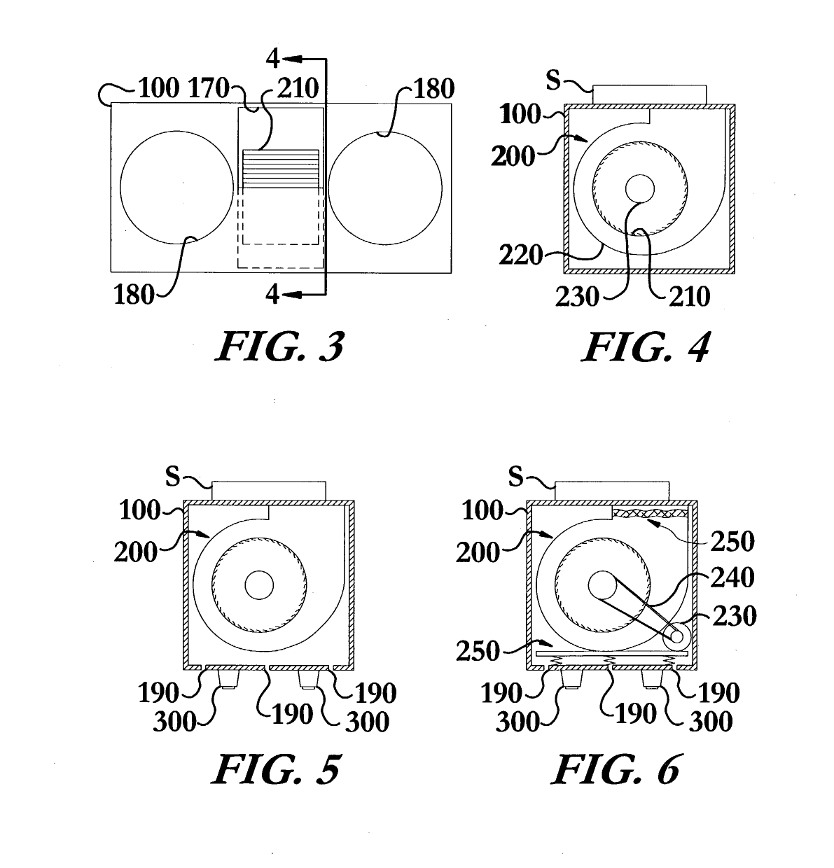

The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention. In its simplest form the apparatus for drying the surface of aggregate in at least one sieve S incorporates a housing 100, at least one discharge opening 170, a fan assembly 200, and an activation device 400 to control the operation of the fan assembly 200, as seen in FIG. 2. The housing 100 has an interior space defined by at least one top surface 110, at least one bottom surface 120, and at least one side surface. The at least one top surface 110 is formed to have at least one sieve opening 180 of a size and configuration to cooperate with the at least one sieve S and to permit fluid communication between the housing interior space and the surrounding atmosphere, illustrated best in FIG. 3. The at least one discharge opening 170 is formed in the housing 100 thereby fluidly connecting the interior space of the housing with the surrounding atmosphere. The fan assembly 200 is positioned within the housing 100 and oriented to draw air from the surrounding atmosphere through the aggregate, the at least one sieve S, and the at least one sieve opening 180, seen in FIG. 4, and discharge air through the at least one discharge opening 170 to the surrounding atmosphere. Lastly, the activation device 400 controls the operation of the fan assembly 200.

Referring again to FIG. 2, in one particular embodiment, the housing 100 further includes a front surface 130, a back surface 140, a left side surface 160, and a right side surface 150, thereby defining the interior space. In this illustrative embodiment, the at least one sieve opening 180 is approximately twelve inches in diameter to cooperate with the sieve size commonly used in an aggregate testing laboratory, but it may be any shape or size. Further, the housing 100 may include any number of sieve openings 180.

A further variation of the apparatus includes at least one drain hole 190 formed in the housing bottom surface 120 to permit fluid communication between the housing interior space and the surrounding atmosphere, as illustrated in FIG. 5 and FIG. 6. Therefore, any moisture that may accumulate in the housing 100 may be permitted to drain from the housing 100, reducing the health risks associated with stagnant water. Further, the bottom surface may be formed to pitch toward the at least one drain hole.

The housing 100 may be constructed of virtually any material, including, but not limited to, sheet metal, plastic, wood, and various composites. The material of construction may further be coated with any number of commercially available coatings to perform such functions as inhibiting corrosion as well as inhibiting microbial growth, among many others.

At least one support device 300 may be attached to the enclosure 100 to elevate the bottom surface 120 from an external surface, as seen in FIG. 5. The at least one support device 300 may be as simple as fixed legs, or may include more advanced adjustability and rotational features.

The at least one discharge opening 170 may be located on any of the surfaces of the enclosure. Just one configuration, that of top surface discharge, is illustrated in the figures. The at least one discharge opening 180 may be outfitted with any number of accessories. As one with skill in the art will appreciate, the at least one discharge opening 180 may be outfitted with a safety screen to prevent objects from coming in contact with the fan assembly 200. Further, the at least one discharge opening 170 may be formed with a duct connection point so that the discharge air may be ducted outside, or other discharge location. Additionally, the at least one discharge opening 170 may incorporate a sound attenuator to minimize the transmission of noise from the discharge opening. The at least one discharge opening 170 size may vary with the airflow of the fan assembly 200 and may be configured in any shape and size.

The fan assembly 200 may incorporate air movement devices in virtually any form. In one particular embodiment, the fan assembly consists 200 of a housed fan having a fan housing 220, a fan wheel 210 rotably and releasable housed in the fan housing, and a motor 230 rotably and releasably joined to the fan wheel 210, as seen in FIG. 4. Such a double inlet centrifugal fan may be either direct drive, or belt drive as seen in FIG. 6. In the belt drive embodiment the motor 230 and the fan wheel 210 are rotably and releasably coupled by at least one belt 240. Alternative embodiments may incorporate a plurality of fans within the housing 100.

The fan assembly 200 may be mounted in the housing 100 in a number of ways. For instance, the fan assembly 200 may be rigidly attached to the housing 100. Alternatively, the fan assembly 200 may be mounted to the housing 100 with a vibration isolation system 250, as seen in FIG. 6. Such vibration isolation system 250 may include an inertia base and a flexible connection at the interface of the fan housing and the at least one discharge opening. Further, the fan assembly 200 may be suspended within the housing 100 with suspension type vibration isolators.

The apparatus includes the activation device 400 for controlling the operation of the fan assembly 200. Such activation device 400 may be as simple as a plug style connector to cooperate with a common electrical connector, or may involve more complex controls. As illustrated in FIG. 2, the activation device 400 may be a switch. Alternatively, as will be seen later, the activation device 400 may consists of electronic controls specifying the start and stop of the fan assembly 200. Similarly, the activation device 400 may incorporate more advanced controls such as variable speed drives to control fan activation, deactivation, and speed.

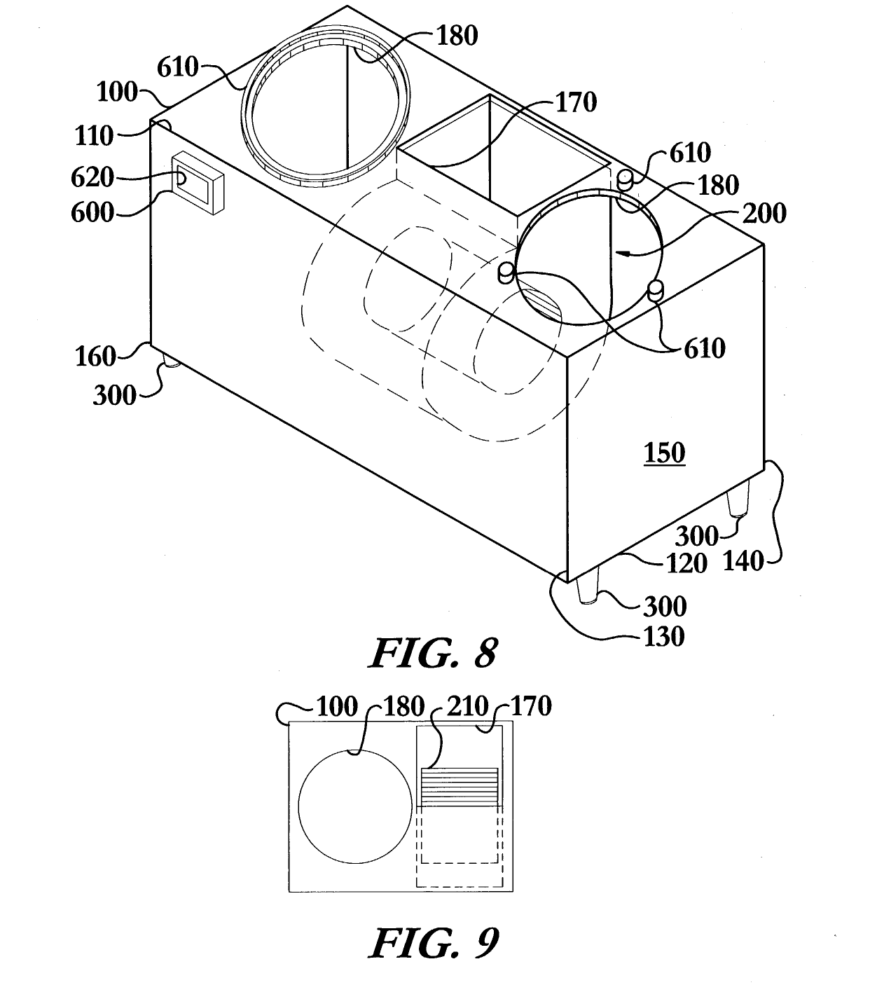

Further embodiments may include a weight measuring system 600 having at least one weight sensor 610 and at least one display device 620, as seen in FIG. 8. The at least one weight sensor 610 may be formed as a sieve receiver adapted to receive and releasably hold the sieve S over the sieve opening 180, as illustrated on the leftmost opening of FIG. 8. Alternatively, the at least one weight sensor 610 may include multiple sensors to cooperate with the sieve S, as illustrated in the rightmost opening of FIG. 8. The at least one display device 620 receives data from the at least one weight sensor 610 and computes a weight associated with the data to be displayed on the at least one display device 620. The weight measurement system 600 may include electronic memory to store and display many weight readings during the process of drying the surface of the aggregate, as well as timing features. The fan system 200 would have to be off while the weight measurement readings were taken so that the negative pressure acting on the interior space, and therefore the sieve S, does not to affect such readings. As one with skill in the art will recognize, a timing/sampling circuit may be incorporated into the weight measurement system 600 such that weight measurements may occur at predetermined intervals and such that the fan system 200 is disabled during such readings, when required.

In a further embodiment, the at least one support device 300 may incorporate the at least one weight sensor 610. This would be particularly useful in the single sieve opening 180 embodiment illustrated in FIG. 9. In such an embodiment the fan assembly 200 would not have to be turned off during the reading since the at least one weight sensor 610 will be measuring the weight of the entire apparatus rather than just the sieve S and its contents.

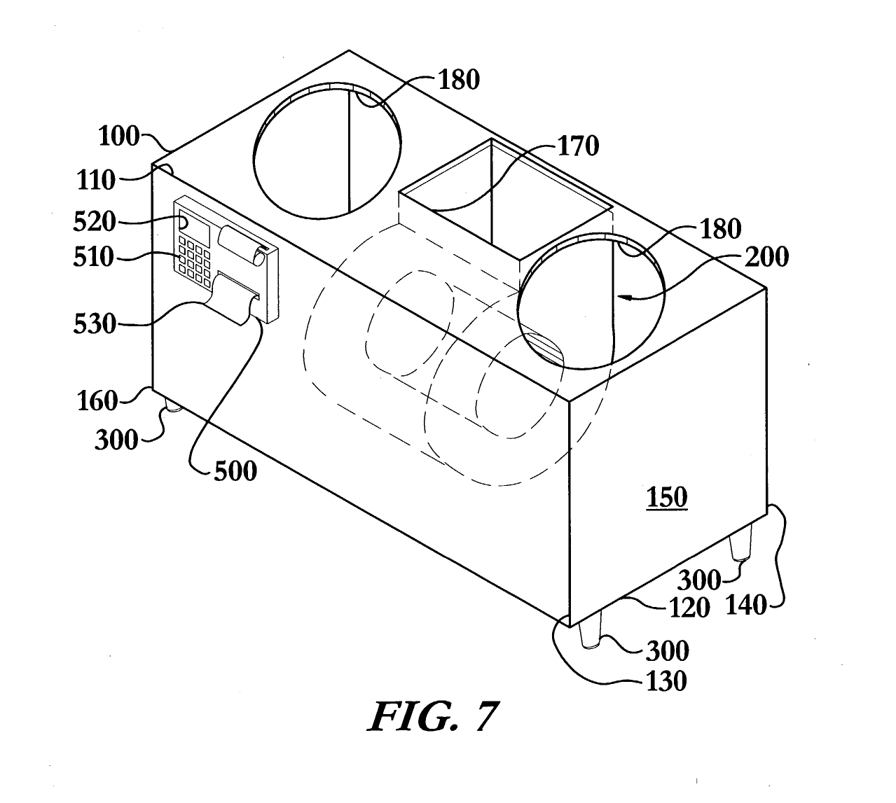

Yet another embodiment may include a control module 500 adapted to receive data from the weight measuring system 600 and at least one input device 510. The at least one input device 510 may be any number of external devices such as a keyboard, or may include an input device 510 built into the control module 500 such as that shown in FIG. 7. The control module 500 may then perform calculations, and display data on one at least one display device 520. The control module 500 may also include memory to retain the input and output data. The calculations performed may include bulk specific gravity of the compacted specimen, the theoretical maximum specific gravity, and the air void percentage in the compacted mix, according to the equations seen above. Further, the control device 500 may incorporate the function of the activation device 400 in controlling the operation of the fan assembly 200. Additionally, the control module 500 may be adapted to transmit data to at least one printer 530, either external to the apparatus or integral to the control module.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims.

The corresponding structures, materials, acts, and equivalents of all means or step plus function elements in the claims below are intended to include any structure, material, or acts for performing the functions in combination with other claimed elements as specifically claimed.

I claim:

1. An apparatus for drying the surface of aggregate, and aggregate/binder mixtures, in at least one sieve, comprising:
a housing having an interior space defined by at least one top surface, at least one bottom surface, and at least one side surface, wherein the at least one top surface is formed to have at least one sieve opening of a size and configuration to cooperate with the at least one sieve and to permit fluid communication between the housing interior space and the surrounding atmosphere;
at least one discharge opening formed in the housing thereby fluidly connecting the interior space of the housing with the surrounding atmosphere;
a fan assembly positioned within the housing and oriented to draw air from the surrounding atmosphere through the aggregate, the at least one sieve, and the at least one sieve opening and discharge air through the at least one discharge opening to the surrounding atmosphere; and
an activation device to control the operation of the fan.

2. The apparatus of claim 1, wherein the fan assembly comprises a fan housing, a fan wheel rotably and releasable housed in the fan housing, and a motor rotably and releasably joined to the fan wheel.

3. The apparatus of claim 1, wherein the at least one side surface further includes a front surface, a back surface, a left side surface, and a right side surface.

4. The apparatus of claim 1, further including at least one drain hole formed in the housing bottom surface to permit fluid communication between the housing interior space and the surrounding atmosphere.

5. The apparatus of claim 1, wherein the fan assembly is mounted to the housing with a vibration isolation system.

6. The apparatus of claim 2, wherein the motor and the fan wheel are rotably and releasably coupled by at least one belt.

7. The apparatus of claim 1, further including at least one support device adapted to elevate the bottom surface from an external surface.

8. The apparatus of claim 1, further including a weight measuring system having at least one weight sensor and at least one display device.

9. The apparatus of claim 8, wherein the at least one weight sensor is configured and located to weigh one of the at least one sieves.

10. The apparatus of claim 8, further including at least one support device adapted to elevate the bottom surface, wherein the at least one support device incorporates the at least one weight sensor.

11. The apparatus of claim 8, further including a control module adapted to receive data from the weight measuring system and at least one input device, perform calculations, and display data on one at least one display device.

12. The apparatus of claim 11, further adapted to transmit data to at least one printer.

13. An apparatus for drying the surface of aggregate, and aggregate/binder mixtures, in at least one sieve, comprising:
a housing having an interior space defined by at least one top surface, at least one bottom surface, and at least one side surface, wherein the at least one top surface is formed to have at least one sieve opening of a size and configuration to cooperate with the at least one sieve and to permit fluid communication between the housing interior space and the surrounding atmosphere;
at least one discharge opening formed in the housing thereby fluidly connecting the interior space of the housing with the surrounding atmosphere;
a fan assembly positioned within the housing and oriented to draw air from the surrounding atmosphere through the aggregate, the at least one sieve, and the at least one sieve opening and discharge air through the at least one discharge opening to the surrounding atmosphere;
a weight measuring system, adapted to weigh the at least one sieve during the drying process, having at least one weight sensor and at least one display device; and
an activation device to control the operation of the fan.

14. The apparatus of claim 13, wherein the fan assembly comprises a fan housing, a fan wheel rotably and releasable housed in the fan housing, and a motor rotably and releasably joined to the fan wheel.

15. The apparatus of claim 13, wherein the at least one side surface further includes a front surface, a back surface, a left side surface, and a right side surface.

16. The apparatus of claim 13, further including at least one drain hole formed in the housing bottom surface to permit fluid communication between the housing interior space and the surrounding atmosphere.

17. The apparatus of claim 13, wherein the fan assembly is mounted to the housing with a vibration isolation system.

18. The apparatus of claim 14, wherein the motor and the fan wheel are rotably and releasably coupled by at least one belt.

19. The apparatus of claim 13, further including at least one support device adapted to elevate the bottom surface from an external surface.

20. The apparatus of claim 13, wherein the weight measuring system further includes at least one weight sensor and at least one display device.

21. The apparatus of claim 20, further including at least one support device adapted to elevate the bottom surface, wherein the at least one support device incorporates the at least one weight sensor.

22. The apparatus of claim 13, further including a control module adapted to receive data from the weight measuring system and at least one input device, perform calculations, and display data on one at least one display device.

23. The apparatus of claim 22, further adapted to transmit data to at least one printer.

24. An apparatus for drying the surface of aggregate, and aggregate/binder mixtures, in at least one sieve, comprising:
a housing having an interior space defined by at least one top surface, at least one bottom surface, and at least one side surface, wherein the at least one top surface is formed to have at least one sieve opening of a size and configuration to cooperate with the at least one sieve and to permit fluid communication between the housing interior space and the surrounding atmosphere, and wherein the bottom surface is formed with at least one drain hole to permit fluid communication between the housing interior space and the surrounding atmosphere;
at least one discharge opening formed in the housing thereby fluidly connecting the interior space of the housing with the surrounding atmosphere;
a fan assembly, having a fan housing, a fan wheel rotably and releasable housed in the fan housing, and a motor rotably and releasably joined to the fan wheel, positioned within the housing and oriented to draw air from the surrounding atmosphere through the aggregate, the at least one sieve, and the at least one sieve opening and discharge air through the at least one discharge opening to the surrounding atmosphere;
a weight measuring system, adapted to weigh the at least one sieve during the drying process, having at least one weight sensor, configured and located to weigh one of the at least one sieves, and at least one display device;
a control module adapted to receive data from the weight measuring system and at least one input device, perform calculations, and display data on one at least one display device; and
an activation device to control the operation of the fan.
